(19) United States
(12) Patent Application Publication
(10) Pub. No.: US 2011/0035249 A1
(43) Pub. Date: Feb. 10, 2011

(54) MAIL ACCEPTANCE SYSTEM AND METHOD

(75) Inventors: Kibaek LEE, Daejeon (KR); Byung-Chul Cha, Daejeon (KR); Hong Suk Hu, Daejeon (KR); Jong Heung Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/699,924

(22) Filed: Feb. 4, 2010

(30) Foreign Application Priority Data
Aug. 6, 2009 (KR) 10-2009-0072513

(51) Int. Cl. G06Q 50/00; G06Q 10/00; G06F 15/16

(52) U.S. Cl. 705/8; 705/338; 709/204

(57) ABSTRACT

A mail acceptance system selects a mail center that is near a client by using mail acceptance information input by the client, calculates transport cost of the selected mail center, selects a mail center that is appropriate for making loads of mail centers equal and minimizing the transport cost as a suitable mail center from among the selected mail centers, and sets a visit and acceptance schedule for visiting and accepting the client's mail.

### CROSS-REFERENCE TO RELATED APPLICATION

This application claims priority to and the benefit of Korean Patent Application No. 10-2009-0072513 filed in the Korean Intellectual Property Office on Aug. 6, 2009, the entire contents of which are incorporated herein by reference.

### BACKGROUND OF THE INVENTION

(a) Field of the Invention

The present invention relates to a mail acceptance system and method. Particularly, the present invention relates to a mail acceptance system and method for accepting a large amount of mail (direct mail, a catalog, etc.).

(b) Description of the Related Art

Conventionally, a client desiring to have a large amount of mail accepted in a post office directly visits the post office or a mail center to submit mail together with information such as quantity of corresponding mail, weight, and fee.

Since a large amount of mail is accepted at one time, differing from private mail, a cost caused by operating a vehicle and transferring the mail to the post office or mail center through the vehicle is generated, and much time is spent until he has mail accepted in the post office or mail center.

Also, since the client frequently has his mail accepted in the mail center late in the afternoon and a large amount of mail accepted in the post office arrives at the mail center late, the time for the mail center to process the mail is usually insufficient. Further, when the mail center selected by the client has an amount of mail that is beyond its processing capacity, it is difficult to process the mail on time and it is also difficult to roll the excess of mail to a neighboring mail center with sufficient capacity.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a mail acceptance system and method for reducing a client's inconvenience caused by acceptance of a large amount of mail and increasing efficiency of accepting and processing a large amount of mail by a postal service provider.

An exemplary embodiment of the present invention provides a mail acceptance system including: a reservation management module for receiving a client's mail acceptance information; a transport network management module for selecting at least one mail center that is near the client and a transportation route for the at least one mail center to visit and accept the client's mail based on the mail acceptance information, and calculating a transport cost corresponding to the transportation route; a mail center monitoring module for calculating available mail processing capacity of the at least one mail center; and an analysis module for selecting a mail center that is appropriate for visit and acceptance from among the at least one mail center based on the transport cost and the available mail processing capacity, and setting a visit and acceptance schedule for the selected mail center to visit and accept the client's mail.

Another embodiment of the present invention provides a mail acceptance method of a mail acceptance system including: selecting at least one mail center that is near the client and a transportation route for visiting and accepting the client's mail for the at least one mail center based on mail acceptance information of a client; calculating a transport cost to be generated when the at least one mail center visits and accepts the client's mail by using the transportation route; calculating available mail processing capacity of the at least one mail center; selecting a mail center that is appropriate for visiting and accepting the client's mail from among the at least one mail center based on the transport cost and the available processing capacity; and controlling the appropriate mail center to set a visit schedule for visiting and accepting the client's mail.

### BRIEF DESCRIPTION OF THE DRAWINGS

FIG. 1 shows a block diagram of a mail acceptance system according to an exemplary embodiment of the present invention.

FIG. 2 shows a flowchart of a mail acceptance method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A mail acceptance system according to an exemplary embodiment of the present invention will now be described with reference to accompanying drawings.

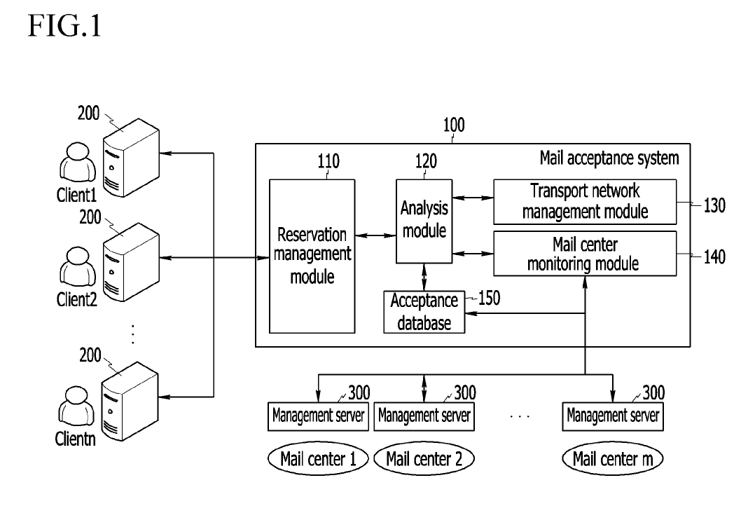

FIG. 1 shows a block diagram of a mail acceptance system according to an exemplary embodiment of the present invention.

Referring to FIG. 1, the mail acceptance system 100 includes a reservation management module 110, a mail center monitoring module 140, a transport network management module 130, an analysis module 120, and an acceptance database (DB) 150.

The reservation management module 110 collects mail acceptance information on a large amount of mail from a client's computerization system 200 that is connected through a network. Here, the mail acceptance information includes at least one of client identity information, amount of mail per mail type, amount of mail per postal code, mail weight, postage, and estimated time of mail acceptance, and the client identity information includes client code and client location information.

Also, the reservation management module 110 receives a visit acceptance schedule for the client's mail visit and acceptance from the analysis module 120, and transmits it to the client's computerization system 200 to provide the client with a visit and acceptance reservation service. It will be exemplified in the exemplary embodiment of the present invention that the client uses a visit and acceptance reservation service by accessing the mail acceptance system 100 through the computerization system 200, and it is also possible in the present invention for the client to access the mail acceptance system 100 online by using a PC or a PDA and use the visit and acceptance reservation service when there no client's computerization system 200.

The analysis module 120 collects information on at least one mail center that is near the corresponding client and transport means information on the corresponding mail center from the transport network management module 130 based on the client's mail acceptance information that is input through the reservation management module 110. Here, the transport means information includes information on available transport means, visit schedule of the corresponding transport means, and transport cost that is generated when using the transport means corresponding to the visit and acceptance. Also, the analysis module 120 collects available mail processing capacity of the corresponding mail center from the mail center monitoring module 140 based on information of the mail center that is near the client and is collected from the transport network management module 130. The analysis module 120 selects a mail center and transport means that are suitable for receiving the client's mail based on the information collected by the transport network management module 130 and the mail center monitoring module 140. Here, the analysis module 120 selects the mail center and the transport means so as to make loads of mail centers equal and to minimize the transport cost. That is, the analysis module 120 selects the mail center that has sufficient mail processing capacity and has a minimized transport cost as the appropriate mail center, and sets a visit schedule for visiting and accepting the client's mail based on the appropriate mail center's transport means information and the client's mail acceptance information. Here, the analysis module 120 can use the estimated time of mail acceptance included in the mail acceptance information input by the client or the visit schedule of the transport means of the mail center that is selected as the suitable one in order to set the visit schedule.

When the visit schedule is set, the analysis module 120 stores the visit schedule in the acceptance DB 150. The visit acceptance schedule stored in the acceptance DB 150 is transmitted to the management server 300 of the corresponding mail center, and is used for the corresponding mail center to manage the schedule of visiting and accepting the client's mail.

The transport network management module 130 detects the location of the corresponding client and the estimated time of acceptance for the client to have the mail accepted based on client identity information and estimated time of mail acceptance included in the client's mail acceptance information provided by the analysis module 120. The transport network management module 130 selects at least one mail center that is near the client according to the client's location, and selects a transportation route available for visit and acceptance at the client's estimated time of mail acceptance or allocates available temporary transportation routes based on the post office transport network of the selected mail center. The transport network management module 130 calculates the transport cost for visiting and accepting the client's mail for the selected transportation route. Here, the post office transport network includes information on the transportation routes for collecting and delivering mail.

The mail center monitoring module 140 periodically accesses the management server 300 of the respective mail centers to check the load states of the corresponding mail centers. Here, load state information includes information of the quantity of mail accepted by the corresponding mail center on the corresponding day, sorted quantity and mechanical processing quantity from among the accepted quantity of mail, and sorted processing results and mechanical processing results of the corresponding day. Upon checking the load states of the respective mail centers of the management server 300, the mail center monitoring module 140 compares them with the predetermined maximum processing capacity for each mail center to calculate available mail processing capacity that can be communicated on time for each mail center.

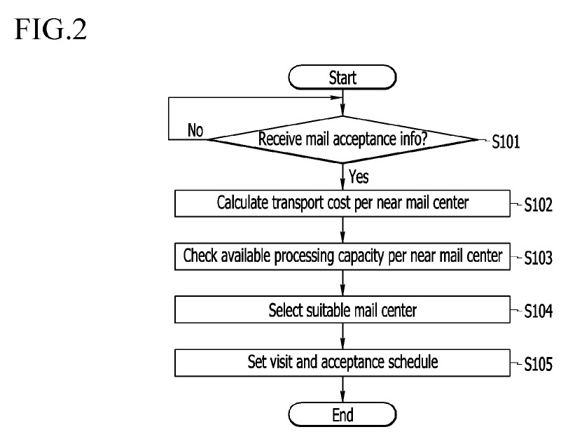

FIG. 2 shows a flowchart of a mail acceptance method by a mail acceptance system according to an exemplary embodiment of the present invention.

Referring to FIG. 2, upon receiving mail acceptance information from the client's computerization system 200 (S101), the reservation management module 110 of the mail acceptance system 100 transmits the same to the analysis module 120.

The analysis module 120 transmits the input mail acceptance information to the transport network management module 130, and the transport network management module 130 checks the location of the corresponding client and the estimated time of acceptance at which the client will have the mail accepted. The analysis module 120 selects at least one mail center that is near the client based on the client's location, and checks the transportation routes of the selected mail center to select at least one transportation route available for visit and acceptance. The analysis module 120 calculates the transport cost for visiting and accepting the client's mail for the selected transportation route (S102).

Also, the analysis module 120 checks available processing capacity of the mail center selected by the transport network management module 130 from the mail center monitoring module 140 (S103), and selects the mail center that is appropriate for visiting and accepting the client's mail based on the transport cost and the available mail processing capacity for the respective mail centers (S104).

The analysis module 120 sets the visit and acceptance schedule for visiting and accepting the client's mail based on the information of the selected suitable mail center (S105), and the reservation management module 110 transmits the visit and acceptance schedule to the client's computerization system 200 to provide the visit and acceptance reservation service to the client. Also, the analysis module 120 stores the visit and acceptance schedule in the acceptance DB 150 to control the mail center that is selected as suitable to visit the client and accept mail.

Accordingly, the client's convenience is increased since he can reserve a visit and acceptance service by inputting mail acceptance information to the mail acceptance system without directly visiting the post office or the mail center so as to have a large amount of mail acceptance accepted.

In addition, the time for transmitting a large amount of mail to the mail center is reduced by directly visiting and accepting the client's large amount of mail by the mail center. Further, an on-time delivery rate is improved and the cost of managing the postal service is reduced since the mail acceptance system sets the visit and acceptance schedule with the intention of averaging the loads of the mail center and minimizing the transport cost. Also, since the post office transport network is used to the visit and acceptance service, utilization of the post office transport network is increased to improve transport efficiency.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A mail acceptance system comprising:
a reservation management module for receiving a client's mail acceptance information;
a transport network management module for selecting at least one mail center that is near the client and a transportation route for the at least one mail center to visit and accept the client's mail based on the mail acceptance information, and calculating a transport cost corresponding to the transportation route;
a mail center monitoring module for calculating available mail processing capacity of the at least one mail center; and
an analysis module for selecting a mail center that is appropriate for visit and acceptance from among the at least one mail center based on the transport cost and the available mail processing capacity, and setting a visit and acceptance schedule for the selected mail center to visit and accept the client's mail.

2. The mail acceptance system of claim 1, wherein
the analysis module selects the mail center that has available mail processing capacity and has the least transport cost as the appropriate mail center.

3. The mail acceptance system of claim 2, wherein
the analysis module sets the visit and acceptance schedule based on the schedule of the transportation route that is selected for the appropriate mail center to visit and accept the client's mail.

4. The mail acceptance system of claim 1, wherein
the reservation management module transmits the visit and acceptance schedule to the client's computerization system.

5. The mail acceptance system of claim 1, wherein
the transport network management module selects the at least one mail center based on client identity information included in the mail acceptance information.

6. The mail acceptance system of claim 1, wherein
the transport network management module selects a transportation route for the at least one mail center to visit and accept the client's mail based on an estimated time of mail acceptance included in the mail acceptance information.

7. The mail acceptance system of claim 6, wherein
the transport network management module selects a transportation route for visiting and accepting the client's mail based on a post office transport network of the at least one mail center, or allocates an available temporary transportation route as a transportation route for visiting and accepting the client's mail.

8. The mail acceptance system of claim 1, wherein
the mail center monitoring module calculates the available mail processing capacity by comparing a load state and maximum processing capacity for the at least one mail center.

9. A mail acceptance method of a mail acceptance system, comprising:
selecting at least one mail center that is near the client and a transportation route for visiting and accepting the client's mail for the at least one mail center based on mail acceptance information of a client;
calculating a transport cost to be generated when the at least one mail center visits and accepts the client's mail by using the transportation route;
calculating available mail processing capacity of the at least one mail center;
selecting a mail center that is appropriate for visiting and accepting the client's mail from among the at least one mail center based on the transport cost and the available processing capacity; and
controlling the appropriate mail center to set a visit schedule for visiting and accepting the client's mail.

10. The mail acceptance method of claim 9, wherein
the selecting of at least one mail center and a transportation route includes:
selecting the at least one mail center based on client location information included in the mail acceptance information; and
selecting a transportation route that is available for visiting and accepting the client's mail at an estimated time of mail acceptance included in the mail acceptance information for the at least one mail center as the transportation route.

11. The mail acceptance method of claim 9, wherein
the selecting of at least one mail center and a transportation route includes
selecting the transportation route from among a post office transport network of the at least one mail center, or allocating an available temporary transportation route of the at least one mail center as the transportation route.

12. The mail acceptance method of claim 9, wherein
the calculating of available mail processing capacity includes
calculating the available mail processing capacity based on a load state and maximum processing capacity for the at least one mail center.

13. The mail acceptance method of claim 9, wherein
the selecting of an appropriate mail center includes
selecting a mail center that has available mail processing capacity and has the least transport cost as the appropriate mail center from among the at least one mail center.

14. The mail acceptance method of claim 9, wherein
the setting includes
controlling the appropriate mail center to set the visit and acceptance schedule based on a schedule of the transportation route that is selected to visit and accept the client's mail.

15. The mail acceptance method of claim 9, wherein
the setting includes
setting the visit and acceptance schedule for the transportation route of the appropriate mail center based on an estimated time of mail acceptance included in the mail acceptance information.

16. The mail acceptance method of claim 9, including
transmitting the visit and acceptance schedule to the client's computerization system.
